(19) United States
(12) Patent Application Publication
(10) Pub. No.: US 2021/0032136 A1
(43) Pub. Date: Feb. 4, 2021

(54) Method and System for Purifying Water Using Photocatalysis

(71) Applicant: CLEMSON UNIVERSITY, Clemson, SC (US)

(72) Inventors: Ezra L. Cates, Clemson, SC (US); Dawei Wang, Clemson, SC (US); Mojtaba Qanbarzadeh, Clemson, SC (US)

(21) Appl. No.: 16/940,987

(22) Filed: Jul. 28, 2020

Related U.S. Application Data
(60) Provisional application No. 62/879,749, filed on Jul. 29, 2019.

(51) Int. Cl. C02F 1/70; C02F 1/32; B01J 27/186; B01J 35/00; B01J 35/02

(52) U.S. Cl. CPC C02F 1/70; C02F 1/325; B01J 27/186; B01J 35/004; C02F 2101/36; B01J 35/0013; C02F 2305/10; C02F 2201/3222; C02F 2201/3227; B01J 35/026

(57) ABSTRACT

Photocatalytic water treatment methods that can be particularly beneficial in degradation of PFAS and reactors and reactor systems that can be useful in carrying out the PFAS degradation protocols are described. Methods utilize bismuth phosphate-based semiconductors as catalysts in particulate or other effective high-surface area water-contacting form. The catalysts can be excited by UV light to induce reduction reactions that degrade or transform PFAS contaminants in the water. Reactor systems include multiple reactors in series and/or parallel. Each reactor includes mixers to encourage turbulent flow within the reactor, control of which is isolated from residence time control within the reactor. The reactors include a light source to deliver about 200 W/L or less of activating radiation emission to the internal volume of the reactor, providing a highly efficient photocatalytic reaction system.

### CROSS REFERENCE TO RELATED APPLICATION

This application claims filing benefit of U.S. Provisional Patent Application Ser. No. 62/879,749, having a filing date of Jul. 29, 2019, entitled “Method for Purifying Water Using Bismuth Phosphate Photocatalysis Under Reducing Conditions,” which is incorporated herein by reference in their entirety.

### FEDERAL RESEARCH STATEMENT

This invention was made with Government support under Grant No. ER18-1599, awarded by the Department of Defense. The Government has certain rights in the invention.

### BACKGROUND

Per-/polyfluorinated alkyl substances (PFAS) are a class of synthetic organic compounds defined as having all or most alkyl carbon atoms saturated by fluorine rather than hydrogen. PFAS demonstrate useful properties and have been incorporated into consumer products as well as fire-fighting foam formulations and are used in the synthesis of polytetrafluoroethylene (PTFE, aka Teflon™). Unfortunately, the manufacturing and use of PFAS has resulted in widespread ground and surface water contamination, particularly from releases associated with chemical plants, firefighting and fire training exercises, and landfill leachates. PFAS are highly recalcitrant and challenging to remove using existing water treatment technologies. They are also potentially harmful even at parts-per-billion (ppb) range concentrations. Both acute and chronic exposure to PFAS in drinking water has been associated with a wide range of health effects, and many states have enacted maximum contaminant levels in the parts-per-trillion (ppt) (ng/L) range.

Due to its recalcitrance, technologies that degrade PFAS into inert products are needed in order to disrupt its cycling through waste streams and natural systems. The Department of Defense is urgently seeking treatment methods which are effective at destructive removal of PFAS from water, and which ideally are deployable in the form of compact and integrated treatment systems application to groundwater monitoring and remediation sites.

Current disposal approaches include incineration, which is costly and of unknown risk with respect to stack gas emissions. Photocatalysis using semiconductors has been shown to degrade some PFAS, though degradation of the perfluorosulfonates (PFSs) has not been demonstrated using this technique. PFSs are one of the major categories of PFAS found in water contaminated by legacy aqueous film-forming foams (AFFFs). As such, management of AFFF-impacted sites requires storage and disposal of PFAS-laden purge water and water from decontamination of drilling equipment

What are needed in the art are methods that can effectively degrade multiple different PFAS, including PFS. Reactors that can be utilized in carrying out such methods, particularly those capable of deployment with currently existing treatment systems, would also be of great benefit to the art.

### SUMMARY

According to one embodiment, disclosed is a water treatment method that can successfully degrade PFAS contaminants. A method can include contacting water with a catalyst comprising a bismuth phosphate, e.g., a surface comprising a bismuth phosphate that contacts the water a such as a high surface particulate suspension comprising a bismuth phosphate or a single large area surface. A method can also include irradiating the water with a light that includes ultraviolet radiation having a wavelength from about 100 nm to about 400 nm. The water can include an electron donor sufficient for a reduction reaction of contaminants contained in the water. In some embodiments, and depending upon the composition of the water to be treated, the method can include combining the water with an electron donor. When added, an electron donor can be combined with the water either prior to or concurrent with the irradiation step. In some embodiments, oxygen can be removed from the water prior to the irradiation. According to the method, PFAS contaminants of the water can be reduced and degraded to form inert products within a relatively short time period, e.g., within minute or hour timescales.

Also disclosed is a water treatment system that can be utilized in one embodiment for a treatment method as described. For instance, a water treatment system can include multiple reactors in series such that a flow out of a first reactor enters a second reactor. Each of the reactors can define an internal volume. Within the internal volume, a reactor can include a mixer or other component to encourage turbulent flow through the volume, e.g., an impeller, a series of rotor blades, or the like, and a light source. The light source can be configured to emit ultraviolet radiation at a predetermined electrical wattage. The ratio of the electrical wattage of the ultraviolet radiation emitted from the light source to the internal volume of the reactor can be about 200 W/L or less. In one embodiment, a water treatment system can include multiple reactors in series with one another, as well as multiple reactors in parallel with one another, to provide a highly efficient and high volume treatment system.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 schematically illustrates direct photocatalytic oxidation of PFAS.

FIG. 2 schematically illustrates direct photocatalytic reduction of PFAS.

FIG. 3 illustrates microparticles of a Petitjeanite Bi₃O(OH)(PO₄)₂ (BOHP) as may be utilized as a catalyst in disclosed methods.

FIG. 4 illustrates micro-rods of a bismuth phosphate (n-BiPO₄) as may be utilized as a catalyst in disclosed methods.

FIG. 5 illustrates micro-sized BiPO₄ (top) and BiPO₄ particles on the nanometer scale (bottom) as may be utilized as a catalyst in disclosed methods.

FIG. 6 schematically illustrates one embodiment of a reactor as described herein.

FIG. 7 illustrates one embodiment for an arrangement of a series of parallel reactors as may be utilized in a water purification approach as described herein.

FIG. 8 illustrates a bench top system as was utilized in Examples described herein.

FIG. 9 presents the degradation rates of several different PFAS with a BOHP catalyst by use of the bench top system (A); fluoride presence upon degradation of perfluorooctane sulfonate (PFOS) with no pH adjustment during processing (B); and fluoride presence upon degradation of PFOS with the pH adjusted as shown.

FIG. 10 presents the mineralization rates upon PFOS degradation in a method as described using a BiPO₄ catalyst.

FIG. 11 presents the effect of pH on mineralization rates upon PFOS degradation in a method as described using a BiPO₄ catalyst.

FIG. 12 schematically illustrates a flow-through batch pilot system utilized in Examples described further herein.

FIG. 13 provides degradation rates for PFAS of Investigation derived waste (IDW) and processed by use of the flow-through batch system as described with methanol added as electron donor and pH adjustment.

FIG. 14 illustrates a BOHP catalyst as described herein.

Repeat use of reference characters in the present specification and drawings is intended to represent the same or analogous features or elements of the present invention.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

Disclosed are photocatalytic water treatment methods that can be particularly beneficial in degradation of PFAS, as well as reactors and reactor systems that can be useful in carrying out the PFAS degradation protocols. Disclosed methods utilize bismuth phosphate-based semiconductors as catalysts in particulate or other effective high surface area water-contacting form. The catalysts can be excited by light in order to induce reactions that degrade or transform chemical or microbial contaminants in the water.

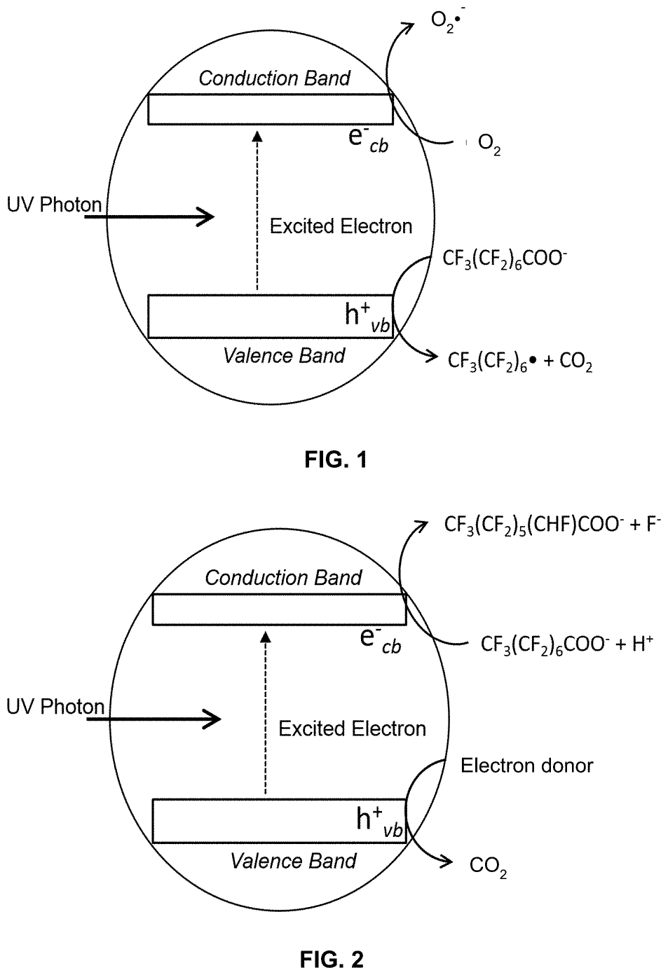

Bismuth phosphate (BiPO₄) has been explored previously as a photocatalyst for advanced oxidation of organic contaminants. FIG. 1 schematically illustrates one such approach for the oxidation of PFAS. In disclosed methods, a bismuth phosphate-based catalyst can contact water under reducing conditions in order to reduce, rather than oxidize, target contaminants. Disclosed methods can be particularly effective in treating recalcitrant poly/perfluoroalkyl substances as illustrated in FIG. 2. Beneficially, disclosed methods and systems can be incorporated into existing water treatment systems and can, in one embodiment, replace the typical TiO₂ catalysts with improved effectiveness against water contaminants.

Disclosed methods can degrade perfluorooctane sulfonate (PFOS), as well as other PFSs and PFAS, to form inert stable products, e.g., carbon dioxide, sulfate, and fluoride ions. While bismuth phosphate semiconductor(s) have been utilized in contaminant degradation previously, the presently disclosed methods incorporate solution chemistry conditions to promote reduction (electron addition) of contaminants, leading to desirable destabilization and destruction. Beneficially, disclosed methods can achieve degradation of multiple different PFAS with desirable kinetics, robustness in the face of complex real water matrices, and simplicity of operation.

Also disclosed is a reactor design that may be utilized in carrying out the treatment methods, as well as for other photocatalytic processes. Most large-scale photocatalytic reactors utilize an annular configuration wherein a lamp is positioned axially in a tubular reactor and the water/catalyst simply flows past the lamp to irradiate and activate the catalyst particles. In such reactors, any turbulence of the water/catalyst suspension is achieved passively by friction with the flow boundaries, and thus, the degree of mixing is determined by the flow rate and superficial velocity of the water. As described further herein, disclosed reactors can develop increased turbulence and a capability to control mixing independently of flow rate. Moreover, disclosed reactor systems can incorporate a ratio of lamp power (and thus, photon input rate) to reactor volume that is lower than what has been proposed in past reactor designs. By using a lower irradiation intensity coupled with a longer residence time, the photons are used more efficiently in disclosed systems, and the electrical energy per order of contaminant destruction per volume (EE/O) is minimized.

As stated, the degradation methods incorporate as catalyst a bismuth phosphate as catalyst. For instance, a catalyst can include BiPO₄ in any polymorph and/or Bi₃O(OH)(PO₄)₂ (BOHP).

The catalyst material can be in any suitable form that can provide for high surface area contact between the bismuth phosphate-based catalyst material and the water to be treated. For instance, the catalyst can be presented in the form of high surface area particles, e.g., micro-sized and/or nano-sized particles, that can be combined with the water to be treated as a suspension and then contacted with light of a suitable wavelength to initiate the contaminant reduction processes. Due to the high reactivity of disclosed systems, the catalyst can be provided with a relatively low surface area as compared to previously known catalyst materials and can still exhibit excellent degradation of PFAS. For instance, catalyst particles can have a surface area of about 2 m²/g and can still be effective. Of course, higher surface area materials are also encompassed herein. Particulate catalyst materials can have a surface area of about 2 m²/g or greater, such as about 2.5 m²/g or greater, about 5 m²/g or greater, about 10 m²/g or greater, about 25 m²/g or greater or about 50 m²/ or greater.

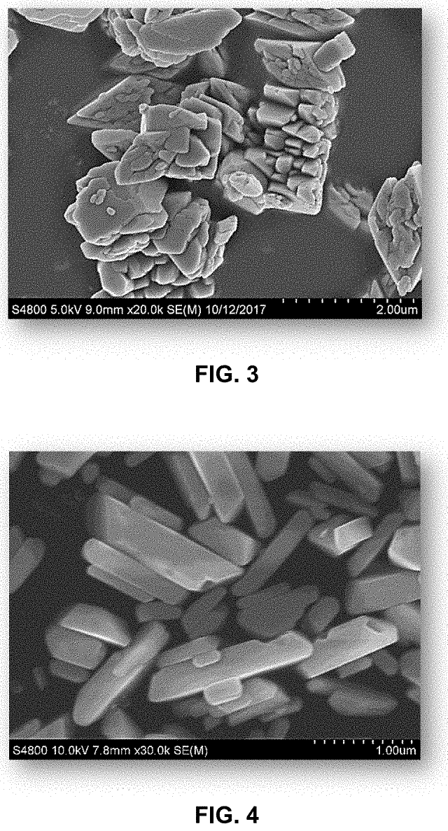

FIG. 3 presents an image of micro-sized BOHP, and FIG. 4 presents an image of micro-sized BiPO₄ as may be utilized in methods. As utilized herein, the term “micro-sized” generally refers to materials having a cross-sectional dimension of from about 1 μm to 1 mm; for instance, from about 1 μm to about 500 μm, from about 2 μm to about 100 μm, or from about 3 μm to about 10 μm, in some embodiments. Micro-sized particles containing a bismuth phosphonate as may be utilized in a process are available in the market (for instance, from Sigma-Aldrich) or may be formed according to standard practice (e.g., hydrothermal, solvothermal, or solid-state synthesis approaches).

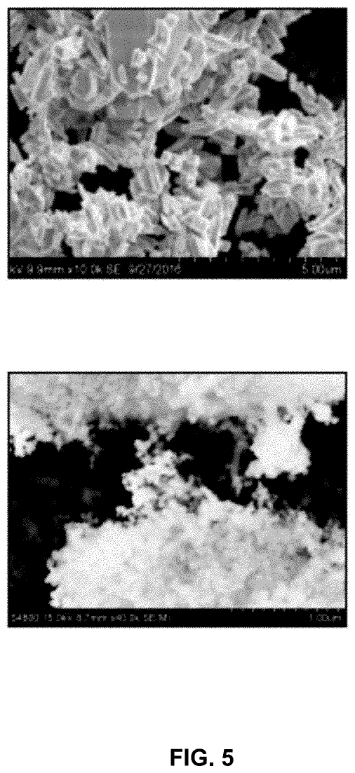

Nano-sized particulates can be utilized in some embodiments. FIG. 5 presents images of micro-sized BiPO₄ in the top panel and smaller BiPO₄ particles on the nano-scale in the lower panel. Nano-sized particulates can present the bismuth phosphate-based materials with a greater surface area, but must also retain adequate surface properties and photocatalytic activity. In general, nano-sized particulates for use in disclosed methods can have a cross-sectional dimension of from about 50 nm to about 1 μm; for instance, about 100 nm or less, such as from about 20 nm to about 100 nm. Nano-sized particulates can be formed according to known methods, for instance via a surfactant modified hydrothermal synthesis approach or for formation of BOHP nanoparticles, through an alkaline hydrothermal treatment of BiPO₄ particles. Surfactants as may be utilized in a formation process can include, without limitation, polyvinylpyrrolidone (PVP), ethylene glycol and poly (ethylene glycol), poly (acrylic acid), and the like.

A catalyst material can include additional components, in addition to a bismuth phosphate-based material. For instance, a catalyst material can include additional metals and/or semiconductors as co-catalyst(s). Co-catalysts can be present in the same structure as the bismuth phosphate-based catalyst or in a separate structure, as desired. For instance, a particulate catalyst material can include first particles that include a bismuth phosphate-based material and second particles that include one or more co-catalysts. In another embodiment, a single particle of a particulate catalyst material can include both a bismuth phosphate-based material and one or more co-catalysts. Examples of co-catalysts can include, without limitation, gold, silver, platinum, carbon, TiO₂, Ga₂O₃, In₂O₃, SiC, Bi₁₂TiO₂O, BiOCl, BiOF, BiOI, BiOBr, and Bi₂O₂CO₃, as well as any combination of two or more co-catalysts.

A bismuth phosphate-based catalyst can include a dopant, which can improve charge carrier lifetime and surface properties. For instance, one or more dopants including, without limitation, lead (Pb), fluoride, nitrogen, silicon, aluminum, lithium, and/or any of the lanthanide series, as well as combinations thereof, can be incorporated into the bismuth phosphate material as a dopant during formation. For example, a salt of the desired dopant (e.g., a sodium salt of fluoride or nitrogen or a nitrate salt of a lanthanide) can be added to a precursor solution during formation of a bismuth phosphate particulate in predetermined amounts to form a doped bismuth phosphate-based particulate catalyst material.

Of course, the form of the bismuth phosphate-based catalyst material is not limited to a particulate and any high surface area contact

The water to be treated can include an electron donor for use in the reduction reaction. In some embodiments, the water can already include sufficient electron donor species. For instance, the water to be treated may already contain electron donor compounds, e.g., organic compounds, in sufficient quantity that additional electron donor compounds need not be added for the reduction of other contaminants in the water (e.g., PFAS).

In one embodiment, one or more electron donor species can be added to the water. By way of example and without limitation, suitable electron donating compounds can include organic electron donor compounds, such as methanol, ethanol, propanol, isopropanol, butanol, citrate, hydrogen (H₂), acetate, formate, or combinations of one or more electron donating species.

The addition of an electron donating species can be utilized in those embodiments in which the water to be treated is free of electron donating species as well as when the water to be treated already contains electron donating species, for instance to ensure desired reactivity of the treatment mixture. The addition amount of an electron donating species can vary, depending for instance upon the species utilized, the contaminant concentration, the presence of electron donors in the contaminated water to be treated, among other factors. In one embodiment, water to be treated can include one or more electron donating species in an amount of about 10 times or greater of the concentration of the targeted contaminant in the water.

To encourage reduction of the targeted contaminants, the water to be treated should be low in dissolved oxygen. As such, it may be beneficial in some embodiments to purge dissolved oxygen from water to be treated prior to carrying out the photocatalytic reduction process. For instance, dissolved oxygen can be removed from the water to be treated by purging the water with a gas such a N₂ or CH₄. As with addition of the electron donor, however, this step may not be necessary if the water to be treated is already essentially anoxic.

To induce reduction of the targeted contaminants, the treatment mixture can be irradiated with light having suitable energy to encourage the reduction reactions. In general, the light can include ultraviolet (UV) light in the range of about 100 nm to about 400 nm. In one embodiment, discussed in more detail below, the light source can include a low pressure mercury vapor lamp, however, any other light source as is known in the art that can provide suitable photonic energy to encourage the reduction reaction is likewise encompassed herein.

While the irradiation can be carried out following complete formation of the treatment mixture, e.g., contact between the water and the catalyst, addition of any electron donating compounds, oxygen purging, this is not a requirement of a process, and in some embodiments, various activities of the process can be carried out concurrently. For instance, water to be treated can be irradiated with suitable electromagnetic energy in conjunction with contact with the bismuth phosphate-based catalyst (for instance, as the water passes over a surface that includes the catalyst at a surface), in conjunction with addition of an electron donating species, in conjunction with purging the water of dissolved oxygen, or in conjunction with any combination of procedural steps.

In some embodiments, the pH of the water can be controlled; for instance, to increase reaction rates. For instance, and as discussed further in the Examples section, maintaining the treatment water at a relatively neutral pH, e.g., from about 6 to about 8, can increase reaction rates. pH control can be attained in one embodiment of addition of an acid, e.g., HCl, prior to or during the photocatalytic reaction. Excessive addition of acid may be counter-productive, however, as excessive anion presence (e.g., chloride or sulfate anion) can decrease reduction reaction rates, as discussed below.

The reaction can be carried out in a single irradiation or in several steps, as desired, for instance by use of multiple contacts in series, through recycle of the treatment mixture through an irradiator, or through some combination thereof, as desired. In those embodiments in which the catalyst material is in the form of a particulate suspension, the catalyst particles may be removed and recycled following a reduction process; for instance, by use of a membrane separation process as is known in the art.

The reduction reaction can beneficially degrade multiple different PFAS, including PFS, which are the most challenging subcategory of PFAS. Using the disclosed photocatalytic bismuth phosphate catalyzed reduction methodology, PFAS may be fully mineralized; for instance, to inert carbon dioxide, sulfate, and fluoride ions in the case of PFS relatively quickly, for instance within hour or minute-range timescales.

While disclosed methods can be carried out using any suitable irradiation contact approach, in one embodiment, a highly efficient reactor system that can utilize a lower energy input as compared to previously known photocatalytic reactor designs can be utilized. Disclosed reactor systems can be easily incorporated in existing water treatment plants, with each individual reactor sized to provide compact and efficient treatment protocols. In addition, a treatment system can be a device to include multiple individual reactors in series and as desired also in parallel. As such, a reactor system can be individually designed to be utilized in any water treatment application, from a small, temporary water treatment process; for instance, a remote clean-up application, or alternatively, in a large permanent and continuous process. The modular design thus allows empirical optimization with a single or multiple reactors and simple scale-up to meet design needs.

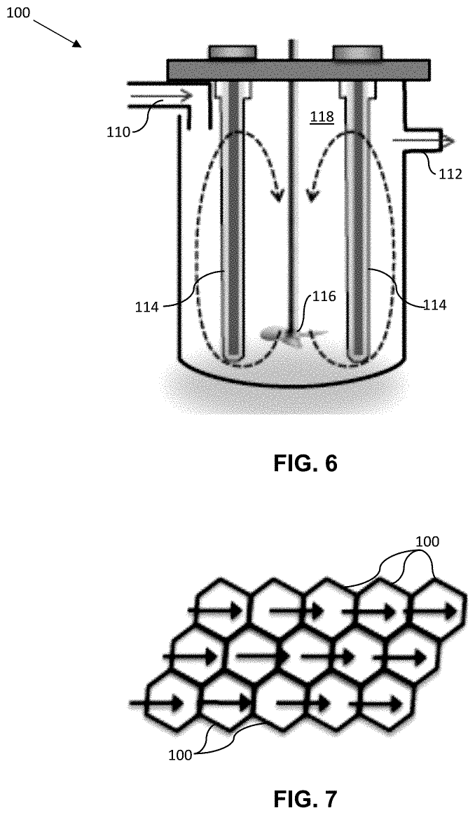

One embodiment of a reactor 100 for use in a reactor system as disclosed is illustrated in FIG. 6. As indicated, a reactor 100 can include an inlet 110, an outlet 112, one or more light sources 114, and a mixer 116. Beneficially, by inclusion of a mixer 116, the reactor can provide for separate control of mixing characteristics (e.g., turbulence of a liquid within the reactor) and residence time of a liquid within the reactor.

The overall size of a reactor is not particularly limited, and can be modified to meet design needs. For instance, in one embodiment, the internal volume of the reactor, e.g., the total volume of the mixing tank 118, can be about 10 L or greater, with the volume available for water to be treated somewhat less than that, e.g., about 80% of the total internal volume, depending upon the size, type, and number of other components including lights, mixers, etc.

The mixer 116 can be in the form of a centrally located impeller, as illustrated, or any other suitable mixing device, e.g., blades located on a rotating axis or blades located on a rotating radial surface. In addition, though illustrated with a single impeller located on an axial shaft near the bottom of the mixing tank 118 (e.g., a reactor can alternatively include a mixer at a different location, e.g., vertically higher in a tank). Moreover, a mixer 116 can include multiple mixers. For instance, a reactor can include multiple centrally located impellers at different vertical heights within a mixing tank. In one embodiment, a mixer can include both centrally located axial impellers, such as impeller 116 as illustrated in FIG. 6, as well as stationary or rotating blades located on an inner surface of the mixing tank, which can encourage additional turbulence in a liquid within the tank 118.

As indicated by the directional arrows in FIG. 6, a mixer 116 can encourage turbulent flow within the tank 118. In general, the mixer 116 can be controlled independently from the rate of flow through the mixing tank, which can provide for improved contact between light emitted from the light source 114 and a water/catalyst mixture within the tank 118 and thereby increase efficiency of the treatment protocol within the tank.

The reactor 100 also include one or more light sources 114. The light sources 114 can be selected to emit suitable light for a particular photocatalytic reaction within the tank. For instance, in the particular case of PFAS reductive degradation as discussed above, a light source 114 can be selected that emits ultraviolet light in a wavelength of from about 100 nm to about 400 nm, or an energy equivalent thereof.

By way of example, a light source 114 can include a low pressure mercury lamp as an ozone-free lamp for use in a reduction reaction as described. Alternatively, an ozone-producing UV lamp can be utilized; for instance, to encourage an oxidation degradation reaction in the tank. In one embodiment, a medium-pressure UV lamp or light-emitting diode (LED)-based ultraviolet source can be used. Moreover, combinations of light sources can be used; for instance, an LED in conjunction with a low or medium pressure UV lamp. In general, any suitable light source can be utilized provided the optical power output provides suitable energy to encourage the desired reactions within the tank 118. For instance, in one embodiment, any light source can be used for which the ratio of photon input rate to volume of material contacted by the light within the tank is equivalent to that which is achieved by a low pressure mercury lamp system with a lamp wattage-to-volume ratio of about 200 W/L.

In one embodiment, lamps 114 can be selected so as to encourage both photocatalytic degradation and photolytic degradation of the contaminant occur. Photolytic degradation can occur via UV-induced photolysis by wavelengths in the range of 100-400 nm, such as 185 nm vacuum UV (VUV) emissions produced by some low pressure mercury lamps. Use of such a lamp in conjunction with a catalytic degradation methodology, such as described herein, can encourage both VUV photolytic degradation and photocatalytic degradation of contaminants contained in a water sample.

As illustrated, the tank 118 can contain multiple light sources 114. For instance, a plurality of light sources can encircle the central axis of the tank 118 in one embodiment, spaced concentric to the central axis or staggered, as desired. The number and location of individual lamps 114 can be varied to ensure contact between the water to be treated and the radiation emitted from the lamps 114.

The particular location of the lamps 114 is not limited, however. For instance, one or more lamps 114 can be positioned against one or more portion(s) of a wall of tank 118 and arranged such that the emitted light radiates toward the central axis of the tank 118 or to another location within the tank 118. Multiple lights can be located in various locations, e.g., concentric between the central axis of the tank combined with along a wall, on the tank floor radiating upward, on the tank ceiling radiating downward, etc., with any suitable combination so as to contact a liquid to be treated with the emitting radiation.

The particular location of each lamp 114, spacings between lamps 114, spacings between each lamp 114 and a mixer 116, spacings between each lamp 114 and the wall of the tank 118, etc. can be modified as would be evident to one of skill in the art, so as to achieve minimal or near-minimal electrical energy per order of contaminant destruction (EE/O) for a target contaminant dissolved in a particular wastewater. Adjustment of said dimensions may be achieved through trial-and-error operation of one vessel operated in batch mode, while monitoring contaminant disappearance rates and electricity consumption by the UV sources and impeller motors, as would be evident to one in the art.

In one embodiment, each lamp 114 can be contained within a protective sleeve, e.g., a quartz or other transparent protective sleeve that can prevent physical contact of the lamp 114 with the liquid contents of the tank 118.

During use, a reactor can operate with high efficiency, for instance at a ratio of electrical wattage of the lamp(s) 114 within the tank 118 to the volume to be treated within the tank (e.g., the total volume of a water/catalyst suspension within a tank 118) and within line-of-sight of at least one lamp 114 within the tank 118 of about 200 W/L or less; for instance, about 50 W/L or less, about 40 W/L or less, about 30 W/L or less, or about 20 W/L or less; for instance, from about 5 W/L to about 25 W/L, or from about 10 W/L to about 20 W/L in some embodiments.

A reactor system can include multiple reactors so as to provide capability of modular design to any desired specification. For instance, addition of multiple reactors in series can increase total treatment time of a wastewater, while addition of reactors in parallel can increase treatment rate of a wastewater. As indicated in FIG. 6, a wastewater can pass into a reactor via an inlet 110 to a tank 118 where the water can be mixed to encourage turbulent flow within the tank as emissions from the lamps 114 contact the water. Other inlets can be incorporated in a tank as desired; for instance, a nitrogen gas flow to remove dissolved oxygen from the wastewater, a second inlet to provide an electron donating compound, or any other reactant or catalyst useful for a particular photocatalytic wastewater treatment process to be carried out within the reactor.

Following a predetermined residence time, the wastewater can be removed from the tank 118 via outlet 112 and delivered to a second tank; for instance, via gravity flow or active pumping. A reactor system can be utilized as a batch or a continuous process, as desired.

The modular system can include individual reactors of any size and shape. In one embodiment, the individual reactors can be designed to provide a compact system. For instance, as illustrated in FIG. 7, a reactor system can include individual reactors of a shape to allow for tight packing, e.g., hexagonal cross sections. As such, a plurality of reactors 100 can be arranged in series and/or in parallel, as in a space-saving honeycomb arrangement.

Disclosed reactor systems can be combined with existing photoreactor/catalyst separation systems or other water treatment protocols, and can achieve valuable water treatment goals within a compact and deployable package. Beneficially, disclosed methods, optionally carried out in disclosed reactor systems, can be easily combined with other treatment methods and systems that target the same contaminants as the reactors 100, e.g., PFAS, or that target other contaminants. For instance, disclosed methods may be applied in conjunction with or as a sequential process to other methods which efficiently treat particular subcategories of PFAS in order to provide comprehensive PFAS removal. Such additional treatment systems can be located either prior to or following a reactor system as described.

Disclosed methods, optionally carried out in disclosed reactor systems, can be faster, in terms of treatment rate, more robust in the presence of real water co-constituents, and simple to deploy and operate. Disclosed methods and systems can be used to treat water contaminated with PFAS, such as wastewater from groundwater monitoring activities near military installations, PFAS-contaminated landfill leachate, or for treatment of concentrate streams (such as membrane retentates or ion exchange brines) from municipal water and wastewater treatment plants, among other useful applications.

The present disclosure may be better understood with reference to the Examples set forth below.

### Example 1

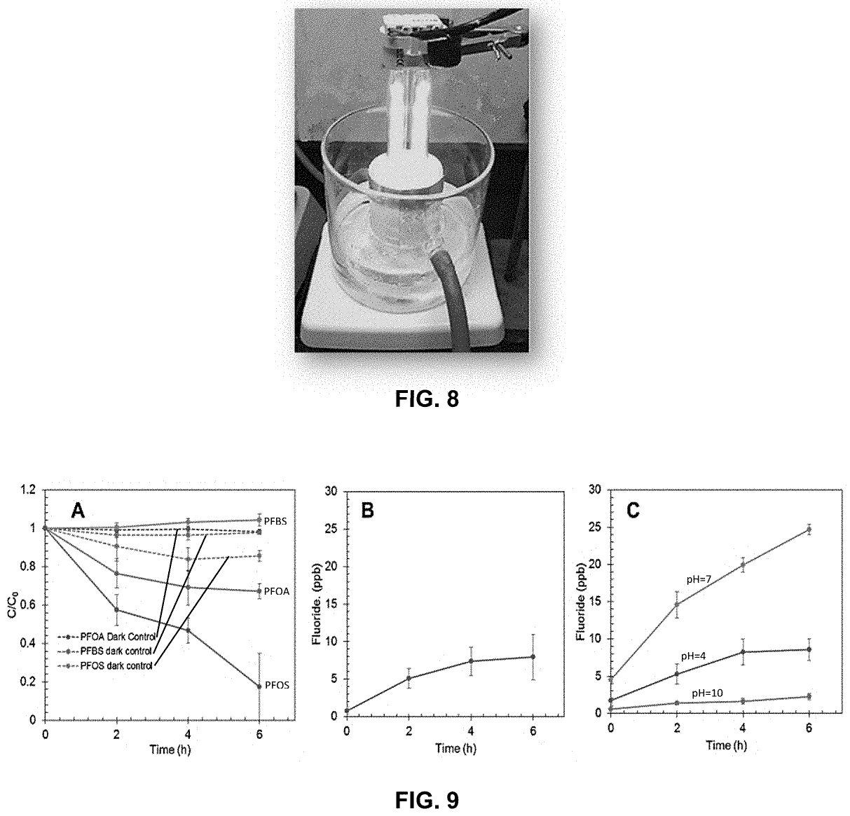

A bench top system (FIG. 8) was utilized to test degradation of several different PFCAs. The PFCAs were dissolved in pure water, nitrogen was bubbled through the water during degradation to purge dissolved oxygen and methanol was added to the mixture as an electron donor. The samples were at natural initial pH and the PFAS was added at C₀=˜100 ppb. Results are shown in FIG. 9. As shown at A, with no pH readjustment PFOS degraded significantly. At B is shown the fluoride data for PFOS degradation with no pH adjustment, and at C is shown the fluoride data for PFOS degradation with the pH readjusted during testing. As shown, maintaining the neutral pH improved the kinetics of the degradation reaction. The dark control samples were carried out in the absence of UV but with all other conditions identical to the other samples.

### Example 2

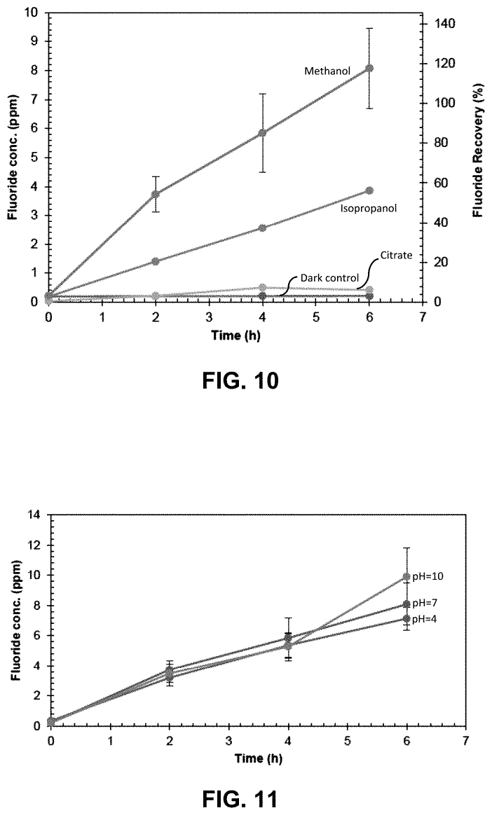

The bench top system of FIG. 8 was used in a reductive photocatalytic process using UV light and a BiPO₄ catalyst for the degradation of PFOS. Fluoride ion generation was monitored via ion exchange chromatography as an indirect indicator of PFOS mineralization. Solutions were prepared using initial PFOS concentration of 10 ppm in deionized water and BiPO₄ catalyst particle concentration of 1.8 g/L. pH was adjusted to 7 with HCl/NaOH. Reaction was carried out using the 300 mL benchtop photoreactor equipped with 18 W UV lamp (254 nm) in a pseudo-annular configuration, under magnetic stirring. Reductive conditions were induced by bubbling with N₂ and addition of 400 ppm of electron donor (methanol, isopropanol, or citrate, as indicated in FIG. 10) every 2 hours. FIG. 10 demonstrates the variation in fluoride concentration over time with the different electron donors. As indicated, mineralization rate was greatest with use of a methanol electron donor. FIG. 11 presents the effect of pH on the PFOS mineralization rate using the BiPO₄ catalyst in the bench top system.

### Example 3

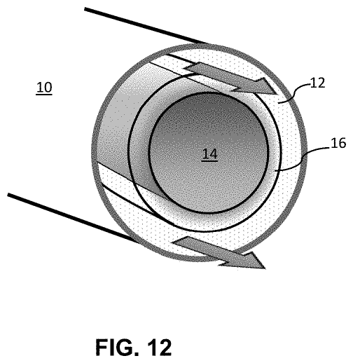

A flow-through batch pilot system was designed that utilized as a reaction flow area a system as schematically illustrated in FIG. 12 that includes a steel jacket 10 surrounding an annular flow field 12 through which a water/catalyst suspension could flow per the directional arrows. A centrally located low pressure mercury lamp 14 surrounded by a quartz sleeve 16 provided photoluminescence to the suspension during a protocol.

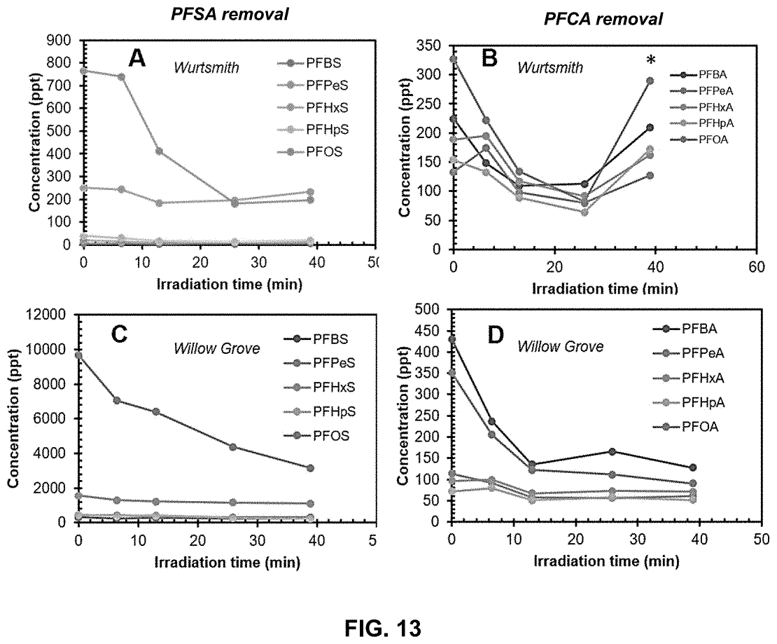

IDW was obtained from two sources known to have PFAS contamination (Wurtsmith Air Force Base in Michigan, and Willow Grove Naval Air Station in Pennsylvania) and examined using the flow-through batch system. The IDW samples were run on the flow-through batch system with methanol added as electron donor and the pH periodically readjusted to about 7. Results are shown in FIG. 13. Following the runs, it was discovered that little-to-no nitrogen purging was achieved due to error, and the presence of dissolved O₂ likely affected the results. However, PFOS degradation was nevertheless observed for both sources.

### Example 4

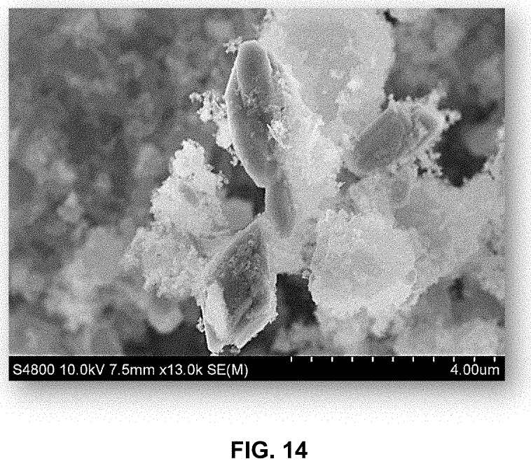

A BOHP catalyst sample (FIG. 14) was examined for long-term stability. To assess stability, the same catalyst batch was used in the flow-through batch system described above for 191 hours. Over that time, no significant change in PFOA degradation rate was observed and periodic dye degradation rate tests shown stable performance. Following the examination, it was found that the sample included TiO₂ contamination, which likely detracted from the performance of the BOHP catalyst.

While certain embodiments of the disclosed subject matter have been described using specific terms, such description is for illustrative purposes only, and it is to be understood that changes and variations may be made without departing from the spirit or scope of the subject matter. cm What is claimed is:

1. A water treatment method comprising:
contacting a volume of water with a catalyst, the catalyst comprising a bismuth phosphate;
irradiating the volume of water in contact with the catalyst and an electron donor with a light that comprises ultraviolet radiation at a wavelength of from about 100 nm to about 400 nm; wherein
upon the irradiation, one or more perfluoroalkyl substances in the water are reduced.

2. The water treatment method of claim 1, wherein the catalyst comprises BiPO₄ and/or Bi₃O(OH)(PO₄)₂.

3. The water treatment method of claim 1, wherein the catalyst comprises a particulate suspended in the volume of water.

4. The water treatment method of claim 3, the particulate comprising micron-sized particles that include the catalyst.

5. The water treatment method of claim 3, the particulate comprising particles having a cross sectional dimension of about 100 nm or less, the particles including the catalyst.

6. The water treatment method of claim 1, the method further comprising contacting the volume of water with a co-catalyst.

7. The water treatment method of claim 6, the co-catalyst comprising gold, silver, platinum, carbon, TiO₂, Ga₂O₃, In₂O₃, SiC, Bi₁₂TiO₂₀, BiOCl, BiOF, BiOI, BiOBr, Bi₂O₂CO₃ or any combination thereof.

8. The water treatment method of claim 1, the catalyst comprising a dopant.

9. The water treatment method of claim 8, the dopant comprising lead, fluoride, nitrogen, silicon, aluminum, lithium, a member of the lanthanide series, or any combination thereof.

10. The water treatment method of claim 1, the method further comprising addition of the electron donor to the volume of water prior to or in conjunction with the step of irradiating the volume of water.

11. The water treatment method of claim 10, the electron donor comprising methanol, ethanol, propanol, isopropanol, butanol, citrate, hydrogen, acetate, formate, or any combination thereof.

12. The water treatment method of claim 1, further comprising purging dissolved oxygen from the volume of water prior to or in conjunction with the step of irradiating the volume of water.

13. A water treatment system comprising a first reactor, the first reactor defining an internal volume, the first reactor comprising an inlet to the internal volume and an outlet from the internal volume, the first reactor comprising a mixing device within the internal volume and one or more light sources, the one or more light sources being configured to emit ultraviolet radiation directed into the internal volume of the first reactor, wherein the ratio of the total electrical wattage of the one or more light sources to the internal volume of the first reactor is about 200 Watts per liter or less.

14. The water treatment system of claim 13, comprising one or more additional reactors in series and/or in parallel with the first reactor, the one or more additional reactors being substantially identical to the first reactor.

15. The water treatment system of claim 13, wherein the mixing device comprises an impeller located on an axial shaft within the internal volume.

16. The water treatment system of claim 13, the one or more light sources emitting ultraviolet light at a wavelength of from about 100 nm to about 400 nm.

17. The water treatment system of claim 16, the one or more light sources comprising a low pressure mercury lamp.

18. The water treatment system of claim 13, the one or more light sources comprising a 185 nm vacuum emitting light source, a medium pressure ultraviolet lamp, a light emitting diode, or a combination thereof.

19. The water treatment system of claim 13, wherein the one or more light sources are located concentrically around an axis of the internal volume, on a wall of the internal volume, or a combination thereof.

20. The water treatment system of claim 13, wherein the first reactor has an external shape comprising a hexagonal cross section.
